(19) United States
(12) Patent Application Publication
(10) Pub. No.: US 2016/0075592 A1
(43) Pub. Date: Mar. 17, 2016

(54) GLASS COMPOSITION, METHOD FOR MANUFACTURING GLASS, OPTICAL CONVERSION MEMBER, METHOD FOR MANUFACTURING OPTICAL CONVERSION MEMBER, ILLUMINATION LIGHT SOURCE, AND LIQUID CRYSTAL DISPLAY DEVICE

(71) Applicant: ASAHI GLASS COMPANY, LIMITED, Tokyo (JP)

(72) Inventors: Tatsuo NAGASHIMA, Tokyo (JP); Masamichi TANIDA, Tokyo (JP); Syuji MATSUMOTO, Tokyo (JP); Tomoharu HASEGAWA, Tokyo (JP)

(73) Assignee: ASAHI GLASS COMPANY, LIMITED, Tokyo (JP)

(21) Appl. No.: 14/947,739

(22) Filed: Nov. 20, 2015

Related U.S. Application Data
(63) Continuation of application No. PCT/JP2014/062797, filed on May 14, 2014.

(30) Foreign Application Priority Data
May 23, 2013 (JP) 2013-109315
Oct. 24, 2013 (JP) 2013-221575

(51) Int. Cl. C03C 3/14; C03C 3/145; C09K 11/64; F21K 99/00; C09K 11/62; C09K 11/59; G02F 1/1335; C03C 3/15; C09K 11/77

(52) U.S. Cl. CPC C03C 3/14; C03C 3/15; C03C 3/145; C09K 11/646; C09K 11/7706; C09K 11/625; C09K 11/59; G02F 1/133617; F21K 9/56; F21Y 2101/02

(57) ABSTRACT

There are provided a glass composition suitable for an optical conversion member containing phosphor particles low in heat resistance, an optical conversion member using the glass composition, and an illumination light source using the optical conversion member. A glass composition comprising, in mol % based on oxides, 5 to 35% of Bi₂O₃, 22 to 80% of B₂O₃, 10 to 48% of ZnO, and 0 to 4% of Al₂O₃, and not substantially containing SiO₂, wherein a total amount of the Bi₂O₃ and the ZnO being 15% or more and less than 70%, an optical conversion member using the glass composition, an illumination light source using the optical conversion member, and a liquid crystal display device using the illumination light source are provided.

### CROSS-REFERENCE TO RELATED APPLICATIONS

This application is a continuation of prior International Application No. PCT/JP2014/062797 filed on May 14, 2014 which is based upon and claims the benefit of priority from Japanese Patent Applications Nos. 2013-109315 filed on May 23, 2013 and 2013-221575 filed on Oct. 24, 2013; the entire contents of all of which are incorporated herein by reference.

### FIELD

Embodiment described herein relate generally to a glass composition, a method for manufacturing glass, an optical conversion member, a method for manufacturing the optical conversion member, an illumination light source, and a liquid crystal display device. This glass composition is particularly suitable for manufacturing an optical conversion member in which a phosphor is dispersed.

### BACKGROUND

A white LED is utilized as a white illumination light source with small power and is expected to be applied to illumination use. Generally, white light of the white LED is obtained by synthesizing blue light emitted from a blue LED element being a light source with yellow, green, red light or the like obtained by converting the color (wavelength) of light of a part of the blue light by a phosphor.

As an optical conversion member converting the color (wavelength) of light from the light source, the one in which an inorganic phosphor is dispersed in glass is known (for example, refer to JP-A 2003-258308). The optical conversion member with such a configuration can utilize the high transmittance of the glass and can efficiently release heat radiated from the LED element to the outside of the optical conversion member. Besides, the optical conversion member (particularly, the phosphor) receives less damage from light and heat, and can obtain reliability for a long time.

There also are known optical conversion members configured to improve the light conversion efficiency by scattering light from the light source by causing light-dispersing particles to exist in glass in which a phosphor is dispersed (refer to JP-B 4286104), or by causing a light scattering layer having light-scattering particles to exist as another layer from glass in which a phosphor is dispersed (refer to JP-A 2011-071404).

### SUMMARY

Incidentally, in the case of dispersing the phosphor in the glass described in Patent References 1 to 3 or the like, the phosphor is heated to high temperature because of a sintering operation in its manufacturing process and the phosphor is sometimes deactivated due to the heating. In particular, the phosphor for wavelength conversion to red light is comparatively low in heat resistance and is thus difficult to keep activity. For this reason, the white LED practically has an optical conversion member containing a phosphor which is convertible the blue light emitted from blue LED element into yellow light dispersed therein. And the white LED emits white light obtained by synthesizing blue light and yellow light.

However, the white light made by synthesizing the blue light and the yellow light does not contain a red component, so that an object irradiated with the synthesized light looks pale and cold unlike the actual color tone. Accordingly, an optical conversion member capable of providing white light having a color rendering property, namely, containing a red light component closer to natural light is required.

Hence, in consideration of the above problems, an object of the present invention is to provide a glass composition capable of sufficiently suppressing a reduction in activity even in the case of containing phosphor particles low in heat resistance and suitable for an optical conversion member, an optical conversion member using the glass composition, an illumination light source using the optical conversion member, and a liquid crystal display device using the illumination light source.

As a result of earnest study, the present inventors have found that a glass composition having a predetermined composition can be fired at low temperature and can keep the activity of a phosphor even if the phosphor is comparatively low in heat resistance at the time when manufacturing an optical conversion member, and have completed the present invention.

Specifically, a glass composition of the present invention contains, in mol % based on oxides, 5 to 35% of Bi₂O₃, 22 to 80% of B₂O₃, 10 to 48% of ZnO, and 0 to 4% of Al₂O₃, and does not substantially contain SiO₂, a total amount of Bi₂O₃ and ZnO being 15% or more and less than 70%.

More specifically, in a first embodiment, a glass composition of the present invention contains, in mol % based on oxides, 5 to 35% of Bi₂O₃, 22 to 80% of B₂O₃, 10 to 48% of ZnO, 0 to 20% of TeO₂, 0 to 4% of Al₂O₃, 0 to 20% of MgO, 0 to 20% of CaO, 0 to 20% of SrO, 0 to 20% of BaO, 0 to 10% of Li₂O, 0 to 10% of Na₂O, 0 to 10% of K₂O, and 0 to 0.5% of CeO₂, and does not substantially contain SiO₂, a total amount of Bi₂O₃ and ZnO being 15% or more and less than 70%.

Further, in a second embodiment, a glass composition contains, in mol % based on oxides, 5 to 35% of Bi₂O₃, 22 to 43% of B₂O₃, 10 to 48% of ZnO, 1 to 20% of TeO₂, 0 to 4% of Al₂O₃, 0 to 10% of MgO, 0 to 10% of CaO, 0 to 10% of SrO, 0 to 5% of BaO, 0 to 5% of Li₂O, 0 to 5% of Na₂O, 0 to 5% of K₂O, 0 to 5% of TiO₂, 0 to 5% of ZrO₂, and 0 to 5% of Nb₂O₅, and does not substantially contain SiO₂, a total amount of Bi₂O₃ and ZnO being 15% or more and less than 70%.

A method for manufacturing glass of the present invention includes melting the glass composition of the present invention at a melting temperature of 1000° C. or lower and using a gold crucible, and then cooling and solidifying the melted glass composition.

Further, an optical conversion member of the present invention is an optical conversion member composed of glass dispersedly containing phosphor particles, wherein the glass is glass formed of the glass composition of the present invention.

A method for manufacturing an optical conversion member of the present invention includes a kneading step of kneading a glass powder, phosphor particles, a resin, and an organic solvent to form slurry, a forming step of forming the obtained slurry into a desired shape, and a firing step of firing the formed slurry into an optical conversion member, wherein the glass powder is formed of the glass composition of the present invention, and a highest temperature of the firing temperature in the firing step is 500° C. or lower.

Furthermore, an illumination light source of the present invention includes the optical conversion member of the present invention, and a light source capable of radiating light to an outside through the optical conversion member.

A liquid crystal display device of the present invention includes a liquid crystal display panel and a backlight illuminating the liquid crystal display panel, wherein an illumination light source composed of the optical conversion member of the present invention and a light source capable of radiating light to an outside through the optical conversion member is provided as the backlight.

The glass composition of the present invention provides glass low in glass transition point (Tg), so that the firing temperature in manufacture of a glass product can be made lower than before. If the firing at low temperature becomes possible, deactivation of the phosphor can be suppressed at the time when manufacturing the optical conversion member by firing. Further, the glass composition of the present invention provides glass low in liquidus temperature, so that the melting temperature in manufacture of the glass can be made lower than before. If the melting at low temperature becomes possible, a gold crucible can be used at the time when manufacturing a glass material.

The optical conversion member and its manufacturing method of the present invention enables of manufacture of the optical conversion member by low-temperature firing as described above, so that the optical conversion member can be made to contain the phosphor dispersed therein while keeping its characteristics without deactivation and have a high quantum conversion yield.

Further, the illumination light source of the present invention uses the optical conversion member of the present invention and therefore can contain the phosphor without deactivation as described above. The characteristics are particularly useful in the case of containing a red phosphor, and in this case, a red component is sufficiently contained as the component of light to be radiated so that illumination light closer to natural light can be obtained. Further, the liquid crystal display device employing the illumination light source as a backlight is excellent in light conversion efficiency and can be expected to reduce in power consumption, and can perform expression with high color reproducibility and high definition.

### DETAILED DESCRIPTION

Hereinafter, a glass composition according to the present invention (hereinafter, also referred to as “this glass composition”), a method for manufacturing glass, an optical conversion member (hereinafter, also referred to as “this optical conversion member”), a method for manufacturing an optical conversion member, an illumination light source, and a liquid crystal display device will be described.

[Glass Composition]

A glass composition of the present invention contains, in mol % based on oxides, 5 to 35% of Bi₂O₃, 22 to 80% of B₂O₃, 10 to 48% of ZnO, and 0 to 4% of Al₂O₃, and does not substantially contain SiO₂, and the total amount of Bi₂O₃ and ZnO is 15% or more and less than 70%.

This glass composition is essentially composed of the above components and may contain other components in a range of not impairing the object of the present invention. In the case of containing other components, they are preferably, in mol % based on oxides, 10% or less, more preferably 5% or less, and furthermore preferably 1% or less, and particularly preferably less than 1%. Hereinafter, the components of the glass composition will be described.

Bi₂O₃ is a component that decreases Tg and increases the refractive index without decreasing the chemical durability of glass, and is an essential component. The content of Bi₂O₃ is 5 to 35%. When the content of Bi₂O₃ is less than 5%, Tg of a glass powder undesirably becomes higher.

On the other hand, when the content is more than 35%, the glass becomes unstable and more likely to be crystallized, and therefore may deteriorate in sinterability. Further, the absorption edge of the glass shifts to a long wavelength side to absorb blue light of an LED element. Further, the refractive index may become too high, and a refractive index difference from that of a phosphor may be increased, so that the light conversion efficiency of an LED may decrease.

B₂O₃ is a network former for the glass, is a component capable of stabilizing the glass, and is an essential component. The content of B₂O₃ is 22 to 80%. When the content of B₂O₃ is less than 22%, the glass becomes unstable and more likely to be crystallized, and therefore may deteriorate in sinterability. On the other hand, when the content of B₂O₃ is more than 80%, the chemical durability of the glass may decrease.

ZnO is a component that decreases Tg and increases the refractive index, and is an essential component. The content of ZnO is 10 to 48%. When the content of ZnO is less than 10%, Tg of the glass powder undesirably becomes higher. On the other hand, when the content of ZnO is more than 48%, the glass becomes unstable and more likely to be crystallized, and therefore may deteriorate in sinterability.

Al₂O₃ is a component that improves the chemical durability and suppresses the reaction with the phosphor during firing, but is not an essential component in the present invention. The content of Al₂O₃ is preferably 0 to 4%. When the content of Al₂O₃ is more than 4%, Tg becomes too high, the liquidus temperature is increased, and therefore the sinterability may be deteriorated. The content of Al₂O₃ is more preferably 3% or less.

Note that both of Bi₂O₃ and ZnO are components that decrease Tg and increase the refractive index, and the total amount of them is 15% or more and less than 70%. When the total amount of Bi₂O₃ and ZnO is less than 15%, Tg of the glass powder undesirably becomes higher. When the total amount of Bi₂O₃ and ZnO is 70% or more, the glass becomes unstable and more likely to be crystallized, and therefore may deteriorate in sinterability.

SiO₂ is a component that increases the stability of the glass, but is not substantially contained in this glass composition because it may make Tg too high, the liquidus temperature may be increased, and the sinterability during low-temperature firing at 500° C. or lower may be greatly deteriorated. Here, “not substantially contained” means that the content is 0.05% or less.

Hereinafter, the present invention will be described in more detail based on a concrete glass composition.

### First Embodiment

### Glass Composition

A glass composition according to a first embodiment of the present invention contains, in mol % based on oxides, 5 to 35% of Bi₂O₃, 22 to 80% of B₂O₃, 10 to 48% of ZnO, 0 to 20% of TeO₂, 0 to 4% of Al₂O₃, 0 to 20% of MgO, 0 to 20% of CaO, 0 to 20% of SrO, 0 to 20% of BaO, 0 to 10% of Li₂O, 0 to 10% of Na₂O, 0 to 10% of K₂O, and 0 to 0.5% of CeO₂, and does not substantially contain SiO₂, and the total amount of Bi₂O₃ and ZnO is 15% or more and less than 70%.

This glass composition is essentially composed of the above components and may contain other components in a range not impairing the object of the present invention. Hereinafter, the components of the glass composition will be described.

Bi₂O₃ is a component that decreases Tg and increases the refractive index without decreasing the chemical durability of glass, and is an essential component. The content of Bi₂O₃ is 5 to 35%. When the content of Bi₂O₃ is less than 5%, Tg of a glass powder undesirably becomes higher. The content is more preferably 8% or more. On the other hand, when the content is more than 35%, the glass becomes unstable and more likely to be crystallized, and therefore may deteriorate in sinterability. Further, the absorption edge of the glass shifts to a long wavelength side to absorb blue light of an LED element. Further, the refractive index becomes too high, and the refractive index difference from that of a phosphor becomes large, so that the light conversion efficiency of an LED may decrease. The content of Bi₂O₃ is more preferably 8 to 32%, furthermore preferably 10 to 30%, and particularly preferably 15 to 27%.

B₂O₃ is a network former for the glass, is a component capable of stabilizing the glass, and is an essential component. The content of B₂O₃ is 22 to 80%. When the content of B₂O₃ is less than 22%, the glass becomes unstable and more likely to be crystallized, and therefore may deteriorate in sinterability. On the other hand, when the content of B₂O₃ is more than 80%, the chemical durability of the glass may decrease. The content of B₂O₃ is more preferably 25 to 60%, furthermore preferably 25 to 55%, and particularly preferably 25 to 45%.

ZnO is a component that decreases Tg and increases the refractive index, and is an essential component. The content of ZnO is 10 to 48%. When the content of ZnO is less than 10%, Tg of the glass powder undesirably becomes higher. On the other hand, when the content of ZnO of more than 48%, the glass becomes unstable and more likely to be crystallized, and therefore may deteriorate in sinterability. The content of ZnO is more preferably 15 to 45%, furthermore preferably 20 to 43%, and particularly preferably 25 to 40%.

Note that both of Bi₂O₃ and ZnO are components that decrease Tg and increase the refractive index, and the total amount of them is 15% or more and less than 70%. When the total amount of Bi₂O₃ and ZnO is less than 15%, Tg of the glass powder undesirably becomes higher. When the total amount of Bi₂O₃ and ZnO is 70% or more, the glass becomes unstable and more likely to be crystallized, and therefore may deteriorate in sinterability. The total amount of them is more preferably 20 or more and 65% or less, furthermore preferably 30 to 60%, and particularly preferably 40 to 55%.

TeO₂ is a component that decreases Tg, increases the refractive index, increases the weather resistance, and decreases the liquidus temperature, but is not an essential component in the present invention. The content of TeO₂ is preferably 0 to 20%. When the content of TeO₂ is more than 20%, TeO₂ may deteriorate the sinterability or react with the phosphor during firing to deactivate the phosphor. The content of TeO₂ is more preferably 16% or less, furthermore preferably 14% or less, and particularly preferably 12% or less.

Al₂O₃ is a component that improves the chemical durability and suppresses the reaction with the phosphor during firing, but is not an essential component in the present invention. The content of Al₂O₃ is preferably 0 to 4%. When the content of Al₂O₃ is more than 4%, Tg may become too high, liquidus temperature may be increased, and the sinterability may be deteriorated. The content of Al₂O₃ is more preferably 3% or less, and furthermore preferably 2% or less.

Alkaline-earth metal oxides such as CaO, SrO, MgO and BaO are components that increase the stability of the glass and improve the sinterability, and are not essential components. The content of each of the alkaline-earth metal oxides is 0 to 20%, namely, the content of MgO is 0 to 20%, the content of CaO is 0 to 20%, the content of SrO is 0 to 20%, and the content of BaO is 0 to 20%, and the total amount of the alkaline-earth metal oxides is preferably 0 to 20%. When the total amount is more than 20%, the stability of the glass may decrease and the absorption edge of the glass may shift to a long wavelength side to absorb blue light of the LED element. The total amount is more preferably 16% or less. Further, as the alkaline-earth metal oxide, BaO is preferable, and the content of BaO is more preferably 1 to 15% and furthermore preferably 1 to 10%.

Alkali metal oxides such as Li₂O, Na₂O and K₂O are components that decrease Tg, and are not essential components in this system. The content of each of the alkali metal oxides is 0 to 10%, namely, the content of Li₂O is 0 to 10%, the content of Na₂O is 0 to 10%, and the content of K₂O is 0 to 10%, and the total amount of the alkali metal oxides is preferably is 0 to 10%. When the total amount is more than 10%, the refractive index may decrease, the chemical durability of the glass may decrease, the reaction with the phosphor during firing may be promoted, and the absorption edge of the glass may shift to a long wavelength side to absorb blue light of the LED element. The total amount is more preferably 0 to 8%, and furthermore preferably 0 to 5%. It is preferable that they are not contained unless there are reasons such as to decrease Tg otherwise.

CeO₂ is not an essential component but may be contained because it functions as an oxidant in the glass. CeO₂ can prevent reduction of Bi₂O₃ in the glass and therefore can stabilize the glass in this system. Reduction of Bi₂O₃ is not preferable because the glass is colored. Further, in the case of using a platinum crucible for manufacturing this glass, Bi₂O₃, when reduced, may react with platinum to damage the crucible. The content of CeO₂ is preferably 0 to 0.5%. When the content is more than 0.5%, the absorption edge of the glass may shift to a long wavelength side to absorb blue light of the LED element. The content of CeO₂ is more preferably 0.2% or less and furthermore preferably 0.1% or less.

SiO₂ is a component that increases the stability of the glass, but is not substantially contained in this glass composition because it may make Tg too high, the liquidus temperature may be increased, and the sinterability during low-temperature firing at 500° C. or lower may be greatly deteriorated. Here, “not substantially contained” means that the content is 0.05% or less.

The glass composition may further contain a substance capable of defoaming internal foam. Examples of the substance include metallic compounds having an oxidation catalyst property such as copper chloride, and elements having a plurality of oxidation numbers by valence change such as antimony oxide. The content of those components is preferably 0 to 15%.

Further, to suppress shift of the absorption edge of the glass to a long wavelength side, F or P₂O₅ may be contained. When F is contained, its content is preferably 0.2 to 10% and more preferably 0.5 to 5%, as external addition, where the components of the glass composition is 100 mol %. Alternatively, when P₂O₅ is contained, its content is preferably 0.2 to 10% and more preferably 0.5 to 5%, as external addition, where the components of the glass composition is 100 mol %. Both of the components can be used in combination.

[Method for Manufacturing Glass]

Next, glass can be formed using this glass composition, and the glass composition only needs to be mixed and melted, and then cooled and solidified according to an ordinary method. It is only necessary to use, as a glass raw material powder for manufacturing a later-described optical conversion member, a glass powder obtained as having a predetermined particle size by grinding the glass, which has been obtained by being melted once and then solidified by this manufacturing method, also according to an ordinary method.

Since the glass obtained by the above-described method for manufacturing glass tends to have a glass liquidus temperature LT lower than that of conventional publicly-known glass, the melting temperature when manufacturing glass can be decreased, and if the glass can be melted at a heating temperature lower than 1000° C., the glass can be manufactured using a gold crucible with the glass composition containing no oxidant such as CeO₂ to a Bi component. On the other hand, when the glass is heated at 1000° C. or higher, the gold crucible cannot be used any longer and therefore a platinum crucible is used.

However, in the case of using the platinum crucible in manufacture of a Bi₂O₃-based glass as with the glass composition of the present invention, unless the reduction of Bi₂O₃ is suppressed during melting by adding an oxidant such as CeO₂ or by oxygen bubbling during melting, Bi₂O₃ may react with platinum and damage the crucible. On the other hand, when CeO₂ is added to the Bi₂O₃-based glass, the absorption edge shifts to a long wavelength side in a glass transmission spectrum, and if the absorption edge shifts to an excitation light wavelength, the light conversion efficiency may decrease. Therefore, it is necessary to decrease the content of Bi₂O₃ in consideration of the absorption edge, but when the content of Bi₂O₃ is decreased, the glass having a glass transition point low enough to sufficiently suppress the deactivation of the phosphor cannot be obtained any longer, and therefore the above-described glass composition is made in consideration of the balance between them.

Note that the oxidant such as CeO₂ is contained in the glass as described above, the absorption edge of the glass may shift to a long wavelength side to absorb blue light of the LED element, and therefore the content of the oxidant is preferably as low as possible. The glass liquidus temperature LT is preferably lower than 1000° C., more preferably 950° C. or lower, and furthermore preferably 900° C. or lower.

The glass formed of this glass composition has a comparatively low glass transition point Tg (hereinafter, simply referred to as “Tg”) and, in particular, preferably has a Tg of 300 to 450° C. When the glass transition point is higher than 450° C., the temperature when firing during a manufacturing step of this optical conversion member increases, so that the phosphor is deactivated depending on the kind of the phosphor for use or the glass reacts with the phosphor, and thereby may decrease the quantum conversion yield of the optical conversion member. To suppress the decrease in the quantum conversion yield, Tg of the glass is preferably 440° C. or lower, more preferably 430° C. or lower, and furthermore preferably 420° C. or lower.

On the other hand, when the glass transition point Tg is lower than 300° C., the firing temperature is low and the decalcification temperature becomes higher than the temperature at which the glass flows, so that the carbon content in the optical conversion member increases and thereby may decrease the quantum conversion yield of the optical conversion member. Further, the transmittance of the optical conversion member decreases and thereby may decrease the light conversion efficiency of the light source. The glass transition point Tg is more preferably 340° C. or higher and furthermore preferably 380° C. or higher. Note that Tg of the glass is calculated from a DTA curve in this Specification.

Further, the density of the glass is preferably 3.5 to 7.0 g/cm³. Outside this range, the specific gravity difference from the later-described phosphor increases, phosphor particles are not uniformly dispersed in the glass powder any longer, and the light conversion efficiency may decrease when they are formed into the optical conversion member. The density is more preferably 3.7 to 6.5 g/cm³ and furthermore preferably 4.1 to 6.0 g/cm³.

Further, the refractive index of the glass is preferably 1.7 to 2.3 at a wavelength of 633 nm. Outside this range, the refractive index difference from the phosphor particles increases, and the light conversion efficiency may decrease when they are formed into the optical conversion member. The refractive index is more preferably 1.75 to 2.2 and furthermore preferably 1.8 to 2.15.

[Optical Conversion Member]

This optical conversion member is composed of glass dispersedly containing the phosphor particles as described above, and the glass forming this optical conversion member here is formed of this glass composition described above. Such an optical conversion member transmits part of light emitted from a light source, converts the wavelength of remaining light, and synthesizes the light to be transmitted and the light with converted wavelength and thereby can radiate light having a desired chromaticity to the outside. This optical conversion member is particularly useful as an optical conversion member for converting a blur light source into white. Further, as the light source used here, an LED element is preferable.

The phosphor particle used for this optical conversion member is not limited in kind as long as the phosphor particle can convert the wavelength of the light source, and examples thereof include publicly-known phosphor particles used for the optical conversion member. Examples of the phosphor particle include oxide, nitride, oxynitride, sulfide, oxysulfide, halide, aluminate chloride, halophosphate chloride and so on. Among the above-described phosphors, the one converting blue light into red, green or yellow is preferable, and the one having an excitation band at a wavelength of 400 to 500 nm and an emission peak (2) at a wavelength of 500 to 700 nm is more preferable.

The phosphor only needs to contain one or more compounds selected from a group consisting of the above-described compounds as long as the phosphor converts the light transmitted through the optical conversion member into a desired color, and concretely may contain a plurality of kinds of compounds in mixture or contain any one of them solely. From the viewpoint of ease of color design, it is preferable to contain one of them solely.

Further, from the viewpoint of increasing the quantum conversion yield, the phosphor is preferably oxide or aluminate chloride. As the phosphor of oxide or aluminate chloride, a garnet-based crystal is more preferable. The garnet-based crystal is excellent in water resistance and heat resistance, and is unlikely to cause deactivation in slurry and deactivation during firing when it undergoes a later-described manufacturing step of the optical conversion member of the present invention. Examples of the above-described garnet-based crystal include a composite oxide of yttrium and aluminum (Y₃Al₅O₁₂; hereinafter abbreviated as YAG in this Specification) and a composite oxide of lutetium and aluminum (Lu₃Al₅O₁₂; hereinafter abbreviated as LAG in this Specification).

Further, in the case where the synthesized light contains a red component, it is preferable to contain a phosphor composed of a CASN-based crystal such as (Ca(Sr)AlSiN₃) or a SiAlON-based crystal, as the phosphor capable of converting the blue light into red.

A 50% particle diameter D₅₀ of the phosphor particle is preferably 1 to 30 μm. When the 50% particle diameter D₅₀ of the phosphor particle is less than 1 μm, the phosphor particle increases in specific surface area and may become likely to deactivate. The 50% particle diameter D₅₀ is more preferably 3 μm or more, furthermore preferably 5 μm or more, and particularly preferably 7 μm or more. On the other hand, when the 50% particle diameter D₅₀ of the phosphor particle is more than 30 μm, the dispersibility in the optical conversion member deteriorates, so that the light conversion efficiency may deteriorate and the chromaticity unevenness may occur. Therefore, the 50% particle diameter D₅₀ is more preferably 20 μm or less and furthermore preferably 15 μm or less. Note that, in this Specification, the 50% particle diameter D₅₀ is a value calculated as a 50% value in an integrated % based on volume from a particle size distribution obtained by a laser diffraction particle size distribution measurement.

The quantum conversion yield of this optical conversion member is preferably 80% or more. When the quantum conversion yield is less than 80%, it is necessary to increase the thickness of the optical conversion member in order to obtain a desired color. When the thickness increases, the transmittance of the optical conversion member may decrease. The quantum conversion yield of the optical conversion member is more preferably 85% or more and furthermore preferably 90% or more. Note that the above-described quantum conversion yield is expressed by a ratio between the number of photons released from a sample as light emission and the number of photons absorbed by the sample when the excitation light is radiated. The above-described number of photons is measured by an integrating sphere method.

This optical conversion member can keep high quantum conversion yield, so that the function of the optical conversion member can be exhibited even if the above-described optical conversion member is thinned. The thickness of the optical conversion member is preferably 50 to 500 μm. Setting the thickness of the optical conversion member to 50 μm or more facilitates handling of the optical conversion member, and makes it possible to suppress breakage of the optical conversion member in particular when the optical conversion member is cut into a desired size. The thickness of the optical conversion member is more preferably 80 μm or more, furthermore preferably 100 μm or more, and particularly preferably 120 μm or more. Setting the thickness of the optical conversion member to 500 μm or less makes it possible to keep the total light flux amount transmitted through the optical conversion member high. The thickness of the optical conversion member is preferably 400 μm or less, more preferably 300 μm or less, and particularly preferably 250 μm or less.

Note that in the case where the phosphor for use is extremely expensive, there is a possibility that the thickness of the optical conversion member is increased at the cost of the total light flux amount to guarantee the light conversion efficiency in order to suppress as much as possible the phosphor amount contained in the optical conversion member. In this case, balancing the total light flux amount and the light conversion efficiency, the thickness of the optical conversion member is sometimes selected between 250 to 500 μm.

The planar shape of this optical conversion member is not particularly limited. For example, in the case where the optical conversion member is used in contact with the light source, the optical conversion member is manufactured with its shape according to the shape of the light source so as to prevent leakage of light from the light source. Since the light source is generally rectangular or circular, the optical conversion member is preferably also rectangular or circular. Further, this optical conversion member is a plate-shape, namely, its cross-sectional shape is preferably rectangular. A plate thickness with less variations in the optical conversion member is more preferable because the variations in color within a plane can be reduced.

This optical conversion member is basically composed of glass dispersedly containing phosphor particles. The mixture fractions of the glass and the phosphor particles are not particularly limited, but the optical conversion member preferably contains, in volume fraction, 1 to 40% of the phosphor particles and 60 to 99% of the glass.

Containing 1% or more of the phosphor particles and 99% or less of the glass makes it possible to increase the quantum conversion yield, convert incident light, and obtain desired color light. The volume fraction of the phosphor particles is more preferably 5% or more, furthermore preferably 7% or more, and particularly preferably 10% or more. The volume fraction of the glass is more preferably 95% or less, furthermore preferably 93% or less, and particularly preferably 90% or less.

When the volume fraction of the phosphor particles is more than 40% and the volume fraction of the glass is less than 60%, the sinterability of the mixture of the phosphor particles and the glass may be impaired and the transmittance of the optical conversion member may decrease. Further, light converted into fluorescent color may increase, resulting in that desired while light cannot be obtained. The volume fraction of the phosphor particles is more preferably 35% or less, furthermore preferably 30% or less, and particularly preferably 25% or less. The volume fraction of the glass is more preferably 65% or more, furthermore preferably 70% or more, and particularly preferably 75% or more.

This optical conversion member may further contain a predetermined heat-resistant filler dispersed in the glass. Containing the heat-resistant filler in such a manner makes it possible to suppress the contraction during firing and uniformize the dispersion state of the phosphor. If the phosphor can be uniformly dispersed as described above, the color variation of the synthesized light radiated from the optical conversion member to the outside can be reduced, and light having a stable desired color shade can be obtained.

In the case of using the heat-resistant filler for this optical conversion member, any heat-resistant filler can be used as long as it has heat resistance against the firing temperature during the manufacture of the optical conversion member, its examples include alumina, zirconia, magnesia and so on, and the heat-resistant filler only needs to contain at least one of them.

In the case where the phosphor particles and the heat-resistant filler are dispersed in the glass, the glass, the phosphor particles, and the heat-resistant filler are contained at predetermined fractions in order to sufficiently suppress the contraction of the optical conversion member during the firing. For example, where the total amount of them is 100%, 3 to 30%, in volume fraction, of the heat-resistant filler is preferably contained. When the content is less than 3%, there is a possibility that the contraction cannot be sufficiently suppressed, and when the content is more than 30%, there is a possibility that the light transmittance of the optical conversion member decreases so as to decrease the use efficiency of the light source.

In this event, in volume fraction, 50 to 96% of the glass and 1 to 40% of the phosphor particles are preferably contained. Setting such contents makes it possible to manufacture the optical conversion member with good balance between the transmittance for light from the light source and the light conversion amount of the phosphor particle, and suppress the contraction during manufacture to thereby suppress occurrence of unevenness in light conversion chromaticity.

Containing the heat-resistant filler as described above makes it possible to suppress the contraction during firing to suppress variations in light conversion chromaticity within a plane and thereby obtain light with less chromaticity unevenness. Further, it is possible to keep the transmittance of the optical conversion member high, and therefore to make the light conversion efficiency excellent while keeping the light flux amount.

[Method for Manufacturing the Optical Conversion Member]

This optical conversion member is preferably composed of a sintered compact of a mixed powder composed of the glass powder, the phosphor particles and, when necessary, the heat-resistant filler. Further, this optical conversion member is more preferably composed of a sintered compact made by firing slurry obtained by kneading the mixed powder, a resin and an organic solvent, and is furthermore preferably composed of a glass sheet obtained by sintering a green sheet which is obtained by painting a transparent resin with the slurry and drying it. Note that the above-described mixture of the resin and the organic solvent is also referred to as a vehicle in this Specification.

For manufacturing this optical conversion member as the sintered compact as described above, it is only necessary to sequentially perform a kneading step of kneading the glass powder, the phosphor particles, the resin, the organic solvent and, when necessary, the heat-resistant filler into slurry, a forming step of forming the obtained slurry into a desired shape, and a firing step of firing the formed slurry into the optical conversion member.

(Kneading Step)

The kneading step in the present invention is for kneading the glass powder, the phosphor particles, the resin, the organic solvent and, when necessary, the heat-resistant filler into slurry, and only needs to be able to uniformly knead those raw materials. For this kneading, it is only necessary to perform kneading using a publicly-known kneading method such as a dissolver, a homomixer, a kneader, a roll mill, a sand mill, an attritor, a ball mill, a vibrator mill, a high-speed impeller mill, an ultrasonic homogenizer, a shaking apparatus or the like. Note that in the case where the optical conversion member contains the heat-resistant filler, it is only necessary to mix also the heat-resistant filler as a raw material component at the same time in the above-described kneading step to obtain slurry.

The glass powder used here may be prepared by mixing a plurality of kinds of publicly-known glass powders so as to satisfy the above-described glass composition, or may be prepared by compounding the components so as to have predetermined thermal characteristics, melting them in an electric furnace or the like, rapidly cooling them to manufacture glass having a predetermined composition, and then grinding and classifying the glass.

The 50% particle diameter D₅₀ of the glass powder is preferably less than 2.0 μm. When the 50% particle diameter D₅₀ is 20 μm or more, the phosphor particles and the heat-resistant filler are not uniformly dispersed in the glass powder any longer, and the light conversion efficiency may decrease and the contraction amount during firing may increase when they are formed into the optical conversion member. The 50% particle diameter D₅₀ is more preferably 1.5 μm or less and furthermore preferably 1.4 μm or less.

Further, a maximum particle diameter Dₘₐₓ of the glass powder is preferably 30 μm or less. When the maximum particle diameter Dₘₐₓ is more than 30 μm, the phosphor particles and the heat-resistant filler are less likely to be uniformly dispersed in the glass powder, and the light conversion efficiency of the phosphor may decrease and the contraction amount during firing may increase when they are formed into the optical conversion member. The maximum particle diameter Dₘₐₓ is more preferably 20 μm or less and furthermore preferably 15 μm or less. Note that, in this Specification, the Dₘₐₓ is a value of the maximum particle diameter calculated by a laser diffraction particle size distribution measurement.

The phosphor particles and the heat-resistant filler are particles described in the above-described optical conversion member.

As the above-described resin, ethyl cellulose, nitrocellulose, acrylic resin, vinyl acetate, butyral resin, melamine resin, alkyd resin, rosin resin or the like can be used. Further, as the above-described organic solvent, aromatic hydrocarbon, aliphatic hydrocarbon, alcohol, ether, ketone, esters or the like can be used. Note that in order to improve the strength of the green sheet, the vehicle preferably contains butyral resin, melamine resin, alkyd resin, rosin resin or the like.

At the time when kneading the above components, it is only necessary to mix the phosphor particles and the glass powder so that the mixture fractions of the phosphor and the glass in the optical conversion member fall within the above-described ranges. More specifically, where the total amount of the phosphor particles and the glass powder is 100%, the contents of the components in the mixed powder are set such that, in volume fraction, the phosphor particles is 1 to 40% and the glass powder is 60 to 99%.

Note that in the case of mixing the heat-resistant filler, where the total amount of the phosphor particles, the heat-resistant filler, and the glass powder is 100%, the contents of the components in the mixed powder are set such that, in volume fraction, the phosphor particles is 1 to 40%, the heat-resistant filler is 3 to 30%, and the glass powder is 50 to 96%.

Containing 1% or more of the phosphor particles and 96% of less of the glass powder makes it possible to increase the quantum conversion yield, efficiently convert incident light, and obtain desired color light.

When the volume fraction of the phosphor particles is more than 40% and the volume fraction of the glass powder is less than 50%, the sinterability of the mixture of the phosphor particles and the glass is impaired and the transmittance of the optical conversion member may decrease. Further, light converted into fluorescent color may increase, resulting in that desired color light cannot be obtained.

Besides, when the volume fraction of the heat-resistant filler is 3% or more, the contraction of the optical conversion member during firing can be efficiently suppressed and the state in which the phosphor particles are uniformly dispersed can be preferably held. Further, when the volume fraction of the heat-resistant filler is more than 30%, the sinterability of the mixed powder is impaired and the transmittance of the optical conversion member may decrease.

The vehicle composed of the resin and the organic solvent only needs to be mixed, to the above-described mixed powder into slurry, by an amount to provide a viscosity capable of forming a predetermined shape in the following forming step.

(Forming Step)

In the forming step in the present invention is for forming the slurry obtained by the kneading step into a desired shape. The forming method is not particularly limited as long as it can provide the desired shape, and its examples include publicly-known methods such as a press forming method, a roll forming method, a doctor blade forming method and so on. A green sheet obtained by the doctor blade forming method is preferable because an optical conversion member with a large area and a uniform thickness can be efficiently manufactured.

The green sheet can be manufactured, for example, by following steps. The glass powder, the phosphor particles, and the heat-resistant filler are kneaded into the vehicle and defoamed, whereby slurry is obtained. The obtained slurry is applied on the transparent resin by the doctor blade method and then dried. After the drying, they are cut into a desired size and the transparent resin is peeled off, whereby a green sheet (kneaded product) is obtained. Further, the green sheets are pressed into a stack, whereby a formed body with a desired thickness can be secured.

Here, the transparent resin to be coated with the slurry is not particularly limited as long as it has a peel property. As the transparent resin used here, a transparent film with a uniform thickness is preferably used so as to obtain a green sheet with a uniform thickness, and as such a transparent film, for example, a PET film can be exemplified.

(Firing Step)

The firing step of the present invention is a step of firing the formed slurry obtained in the forming step to sinter it into an optical conversion member. The firing in this firing step is for sintering the mixed powder to obtain glass dispersedly containing the phosphor particles and the heat-resistant filler, and a glass body only needs to be manufacture by the publicly-known method.

The condition of the firing step is not particularly limited as long as it can perform firing to form a glass body, but the firing atmosphere is preferably a reduced pressure atmosphere of 10³ Pa or less or an atmosphere with an oxygen concentration of 1 to 15%. Further, the highest temperature of the firing temperature in this step is 500° C. or lower, and the highest temperature is preferably in a range of 400 to 490° C. Besides, the firing time is preferably in a range of 1 to 10 hours. If the method for manufacturing the optical conversion member in the present invention is performed outside the above ranges, the quantum conversion yield of the optical conversion member may decrease.

[Illumination Light Source]

The illumination light source of the present invention is composed of the above-described optical conversion member and a light source capable of radiating light to the outside through the optical conversion member.

The light source, combined with the optical conversion member obtained as described above, can be utilized as an illumination light source that emits a desired color. The optical conversion member, when designed to be contacted with the light source, is preferable because it prevents leakage of light. Besides, as the light source, an LED element is preferable, and a blue LED element is more preferable. The LED element, when used as the light source, can be utilized as an LED illumination light source.

[Liquid Crystal Display Device]

Further, the case of combining the above-described optical conversion member and the light source to constitute a liquid crystal display device will be described. More specifically, the liquid crystal display device in this embodiment is characterized by including a liquid crystal display panel and a backlight illuminating the liquid crystal display panel, in which an illumination light source composed of the optical conversion member and a light source capable of radiating light to the outside through the optical conversion member is provided as the backlight.

<Backlight>

The backlight used in this embodiment is composed of the above-described optical conversion member and a light source capable of radiating light to the outside through the optical conversion member.

The light source combined with the optical conversion member obtained as described above can be utilized as the backlight for the liquid crystal display device which can provide high luminance and color reproducibility over a wide range. The optical conversion member, when designed to be contacted with the light source, is preferable because it can prevent leakage of light. Besides, as the light source, an LED element is preferable and a blue LED element is more preferable, and a backlight capable of radiating white light is preferable.

<Liquid Crystal Display Panel>

The liquid crystal display panel used in this embodiment can be used without any particular limitation as long as it is a publicly-known liquid crystal display panel. The liquid crystal display panel has an alignment film provided between two glass plates provided with polarization filter, and changes the alignment of liquid crystal molecules by application of voltage to increase and decrease the light transmittance, and thereby displays an image.

In the liquid crystal display device configured as described above, the liquid crystal display panel can be illuminated, for example, with bright white light with a wide color gamut by three primary colors of light since the illumination light source of the present invention is used for the backlight. Accordingly, a pure white color with high luminance can be obtained on the display screen of the liquid crystal display panel, color reproducibility is excellent, and the quality of the display screen can be improved.

### Second Embodiment

Next, a second embodiment of the present invention will be described. This embodiment is a glass composition with which glass with a low glass transition point can be obtained and the weather resistance becomes better.

More specifically, an optical conversion member is made less likely to be affected by its use application, place to be used and so on, and the environmental temperature experienced by the optical conversion member increasingly exceeds 100° C. accompanying an increase in luminance of the light source. The above states with influence of water cause a significant decrease in light conversion efficiency. Generally, low-softening point glass is used for phosphor with comparatively low heat resistance, but the low-softening point glass tends to deteriorate in weather resistance, and therefore glass which can be fired at low temperature and is excellent in weather resistance is required.

A glass composition according to this embodiment satisfies such a requirement and contains, in mol % based on oxides, 5 to 35% of Bi₂O₃, 22 to 43% of B₂O₃, 10 to 48% of ZnO, 1 to 20% of TeO₂, 0 to 4% of Al₂O₃, 0 to 10% of MgO, 0 to 10% of CaO, 0 to 10% of SrO, 0 to 5% of BaO, 0 to 5% of Li₂O, 0 to 5% of Na₂O, 0 to 5% of K₂O, 0 to 5% of TiO₂, 0 to 5% of ZrO₂, and 0 to 5% of Nb₂O₅, and does not substantially contain SiO₂, and the total amount of Bi₂O₃ and ZnO is 15% or more and less than 70%.

This glass composition is essentially composed of the above components and may contain other components in a range not impairing the object of the present invention. Hereinafter, the components of the glass composition will be described mainly for a part different from the first embodiment.

Though B₂O₃ is an essential component as in the first embodiment, its content is 22 to 43% in this embodiment, and its upper limit value is lower than that in the first embodiment. This is because when the content of B₂O₃ is more than 43%, not only the chemical durability of glass but also the weather resistance may decrease. In this embodiment, the content of B₂O₃ is more preferably 25 to 40% and furthermore preferably 25 to 38%.

TeO₂ is an essential component unlike the first embodiment. In this embodiment, the content of TeO₂ is 1 to 20% and its lower limit value is higher than that in the first embodiment. This is because when the content of TeO₂ is less than 1%, the weather resistance of the glass may decrease. In this embodiment, the content of TeO₂ is more preferably 2 to 16% and furthermore preferably 3 to 12%.

Alkaline-earth metal oxides such as MgO, CaO, and SrO are not essential components as in the first embodiment. In this embodiment, the content of each of MgO, CaO, and SrO is 0 to 10% and its upper limit value is lower than that in the first embodiment. This is because when the content of each of the components is more than 10%, the weather resistance of the glass may decrease. On the other hand, BaO is a component that becomes a catalyst promoting the reaction with moisture under a high temperature and humidity environment and may significantly decrease the weather resistance in the glass containing Bi₂O₃ and B₂O₃ as in this embodiment, and therefore the content of BaO is 0 to 5%.

The total amount of the alkaline-earth metal oxides is preferably 0 to 10%. When the total amount is more than 10%, the weather resistance of the glass may decrease. The total amount is preferably 8% or less. Further, in the case of using the alkaline-earth metal oxide, use of MgO is preferable and its content is preferably 1 to 6%.

Li₂O, Na₂O and K₂O are not essential component as in the first embodiment. In this embodiment, the content of each of Li₂O, Na₂O and K₂O is 0 to 5%, the total amount of them is preferably 0 to 5%, and its upper limit value is lower than that in the first embodiment. This is because when each of the contents and the total amount of those components is more than 5%, the weather resistance of the glass may decrease. Each of the contents and the total amount of those components is preferably 0 to 3% and more preferably 0 to 1%.

TiO₂, ZrO₂ and Nb₂O₅ are components that increase the refractive index, increase the weather resistance, and increase the chemical resistance, and are not essential components in this system. These components are contained such as 0 to 5% of TiO₂, 0 to 5% of ZrO₂, and 0 to 5% of Nb₂O₅, and the total amount of them is preferably 0 to 5%. When the total amount of them is more than 5%, the stability of the glass may decrease, Tg may become too high, and the absorption edge of the glass may shift to a long wavelength side to absorb blue light of an LED element. The total amount is preferably 4% or less and more preferably 3% or less.

Note that the weather resistance of the glass in the Specification was evaluated by using, as an index, the haze value calculated by the method illustrated below. More specifically, both surfaces of a glass plate with a thickness of 1 mm and a size of about 30 mm×30 mm were subjected to mirror polishing with a cerium oxide, and cleaned with a calcium carbonate and a neutral detergent, whereby a glass substrate was obtained. The obtained glass substrate was put into a highly-accelerated life testing machine and left for 24 hours in a water vapor atmosphere of 0.2 Mpa at 120° C., and then a haze value was measured with a C light source using a haze measurement device and was used as the index for the weather resistance.

The weather resistance of the glass in this embodiment preferably has a haze value of 10% or less. When the haze value is more than 10%, the total light transmittance of the glass may decrease so that when it is formed into an optical conversion member, the light conversion efficiency decreases, or moisture reaches the phosphor dispersed in the optical conversion member and reacts therewith to decrease the quantum conversion yield. This haze value is more preferably 5% or less, more preferably 3% or less, and particularly preferably 1% or less. The haze value in the glass plate before being put into the highly-accelerated life testing machine is typically 0.1 to 0.3%.

### EXAMPLES

Hereinafter, the present invention will be described in more detail based on Examples and Comparative Examples. The present invention should not be construed limited to those Examples. Examples of the glass for the optical conversion member of the present invention (Examples 1-1 to 1-30, Examples 1-44 to 46) and Comparative Examples (Examples 1-31 to 1-43) are listed in Tables 1 to 5, and Examples of the optical conversion member of the present invention (Examples 2-1 to 2-24, 2-41 to 2-45), Comparative Examples (Examples 2-25, 2-28 to 2-34, 2-36 to 2-40), and Reference Examples (Examples 2-26, 2-27, 2-35) are listed in Tables 6 to 11. Note that “-” in Tables 1 to 5 indicates unevaluated.

### Example 1

### Manufacture of Glass

The raw materials of the components were compounded to produce the compositions listed in Tables 1 to 5, in mol % based on oxides, and the glass raw materials were mixed to form into glass compositions. Note that each of Examples 1-45 and 1-46 contained 2 mol % of F, as external addition, to 100 mol % of glass. The glass compositions were heated and melted by the electric furnace in a platinum crucible at 1200° C. for Examples 1-1 to 1-3, 1-31 and 1-34 to 1-39 and in a gold crucible at 950° C. for Examples 1-4 to 1-30, 1-32, 1-33 and 1-40 to 1-46, and a part of each melt was rapidly cooled by rotary rolls to form into a glass ribbon. Further, a part of the melt was cooled after formation, whereby a glass plate was obtained.

The obtained glass ribbons were ground by a ball mill, and put through a sieve having a mesh of opening of 150 μm, and further subjected to air-classifying, whereby powders (glass powders) of Examples 1-1 to 1-46 were obtained.

The glass transition point Tg of the obtained glass powder was measured using a differential thermal analyzer (manufactured by Rigaku Corporation, trade name: TG8110). Besides, the 50% particle diameter D₅₀ of the glass powder was calculated by a laser diffraction particle size distribution measurement (manufactured by Shimadzu Corporation, apparatus name: SALD2100).

Besides, the liquidus temperature LT was evaluated as follows. More specifically, each sample obtained by putting about 1 g of the obtained glass powder on a platinum dish and holding it in an electric furnace at a predetermined temperature for about 2 hours, and then taking it out of the furnace and rapidly cooling it, was observed under a microscope, and a temperature zone where crystals were observed was regarded as the liquidus temperature LT. The test was carried out at temperatures of the electric furnace in this event from 850 to 1000° C. in increments of 50° C.

Further, the obtained glass was subjected to measurement of a specific gravity d by the Archimedes method and then processed into a plate shape with a thickness of 1 mm and a size of 20 mm×20 mm, and then subjected to mirror polishing of its both surfaces with a cerium oxide into a sample plate, and its refractive index n to light with a wavelength of 633 nm was measured using a model 2010 prism coupler manufactured by Metricon corporation.

A wavelength λ_{T30%} of a transmittance 30% at a glass thickness of 1 mm is a wavelength at which a transmittance obtained by measuring the sample plate with a spectrophotometer (manufactured by PerkinElmer, Inc., apparatus name: Lambda950) is 30%.

Besides, the haze value being the index for the weather resistance was obtained as follows. The sample plate with a thickness of 1 mm and a size of 30 mm×30 mm obtained by processing by the same method as described above was cleaned with a calcium carbonate and a neutral detergent, then put into a highly-accelerated life testing machine (manufactured by ESPEC CORP., trade name: Unsaturated Pressure Cooker EHS-411M), and left at rest for 24 hours in a water vapor atmosphere of 0.2 Mpa at 120° C. Then, a haze value of the sample plate was measured with a C light source using a haze measurement device (manufactured by Suga Test Instruments Co., Ltd., trade name: Haze Meter HZ-2).

TABLE 1

| | | Example | Example | Example | Example | Example | Example | Example | Example | Example | Example |
|---|---|---|---|---|---|---|---|---|---|---|---|
| | | 1-1 | 1-2 | 1-3 | 1-4 | 1-5 | 1-6 | 1-7 | 1-8 | 1-9 | 1-10 |
| Composition | Bi₂O₃ | 13 | 16 | 16 | 17 | 17 | 30 | 25 | 25 | 18 | 10 |
| (mol %) | B₂O₃ | 27.8 | 29.8 | 29.8 | 32.9 | 33 | 39.9 | 54.9 | 55 | 32.9 | 47.3 |
| | SiO₂ | 0 | 0 | 0 | 0 | 0 | 0 | 0 | 0 | 0 | 0 |
| | Al₂O₃ | 2 | 3 | 3 | 1 | 1 | 0 | 0 | 0 | 2 | 2.5 |
| | MgO | 3 | 0 | 0 | 0 | 0 | 0 | 0 | 0 | 0 | 0 |
| | SrO | 0 | 0 | 0 | 0 | 0 | 0 | 0 | 0 | 0 | 0 |
| | BaO | 15 | 13 | 18 | 7 | 7 | 0 | 0 | 0 | 5 | 10 |
| | ZnO | 39 | 38 | 33 | 42 | 42 | 30 | 20 | 20 | 38 | 15 |
| | Na₂O | 0 | 0 | 0 | 0 | 0 | 0 | 0 | 0 | 4 | 0 |
| | K₂O | 0 | 0 | 0 | 0 | 0 | 0 | 0 | 0 | 0 | 0 |
| | Nb₂O₅ | 0 | 0 | 0 | 0 | 0 | 0 | 0 | 0 | 0 | 0 |
| | TiO₂ | 0 | 0 | 0 | 0 | 0 | 0 | 0 | 0 | 0 | 0 |
| | P₂O₅ | 0 | 0 | 0 | 0 | 0 | 0 | 0 | 0 | 0 | 0 |
| | TeO₂ | 0 | 0 | 0 | 0 | 0 | 0 | 0 | 0 | 0 | 15 |
| | CeO₂ | 0.2 | 0.2 | 0.2 | 0.1 | 0 | 0.1 | 0.1 | 0 | 0.1 | 0.2 |
| | MnO₂ | 0 | 0 | 0 | 0 | 0 | 0 | 0 | 0 | 0 | 0 |
| | Bi₂O₃ + ZnO | 52 | 54 | 49 | 59 | 59 | 60 | 45 | 45 | 56 | 25 |

| | | | | | | | | | | |
|---|---|---|---|---|---|---|---|---|---|---|
| Reflectance n@ 633 nm | 1.86 | 1.89 | 1.88 | 1.91 | 1.91 | 2.03 | 1.94 | 1.94 | 1.89 | 1.81 |
| Glass transition point | 433 | 425 | 421 | 428 | 429 | 407 | 450 | 450 | 406 | 450 |
| Tg [° C.] | | | | | | | | | | |
| Liquidus temperature | 900-950 | 950-1000 | 950-1000 | <850 | <850 | <850 | <850 | <850 | <850 | <850 |
| LT [° C.] | | | | | | | | | | |
| Density d [g/cm³] | 5.37 | 5.52 | 5.52 | 5.66 | 5.65 | 6.40 | 5.74 | 5.70 | 5.46 | 4.65 |
| Wavelength λ_{T30%} [nm] | 442 | 443 | 444 | 433 | 392 | 451 | 434 | 381 | 432 | 406 |
| Haze value [%] | — | — | — | — | 22.62 | — | — | — | — | 14.28 |

TABLE 2

| | | Example | Example | Example | Example | Example | Example | Example | Example | Example | Example |
|---|---|---|---|---|---|---|---|---|---|---|---|
| | | 1-11 | 1-12 | 1-13 | 1-14 | 1-15 | 1-16 | 1-17 | 1-18 | 1-19 | 1-20 |
| Composition | Bi₂O₃ | 8 | 12 | 15 | 14 | 13 | 14 | 17 | 28 | 25 | 25 |
| (mol %) | B₂O₃ | 28.8 | 29.8 | 27.9 | 28.9 | 27.9 | 27.9 | 30 | 26 | 26 | 35 |
| | SiO₂ | 0 | 0 | 0 | 0 | 0 | 0 | 0 | 0 | 0 | 0 |
| | Al₂O₃ | 3 | 2 | 1 | 1 | 1 | 0 | 1 | 1 | 1 | 0 |
| | MgO | 0 | 0 | 0 | 0 | 0 | 0 | 0 | 0 | 0 | 0 |
| | SrO | 0 | 0 | 0 | 0 | 0 | 0 | 0 | 0 | 0 | 0 |
| | BaO | 16 | 7 | 5 | 3 | 5 | 3 | 2 | 5 | 3 | 0 |
| | ZnO | 29 | 37 | 39 | 39 | 37 | 39 | 40 | 30 | 35 | 20 |
| | Na₂O | 0 | 0 | 0 | 0 | 0 | 0 | 0 | 0 | 0 | 0 |
| | K₂O | 0 | 0 | 0 | 0 | 0 | 0 | 0 | 0 | 0 | 0 |
| | Nb₂O₅ | 0 | 0 | 0 | 0 | 0 | 0 | 0 | 0 | 0 | 0 |
| | TiO₂ | 0 | 0 | 0 | 0 | 0 | 0 | 0 | 0 | 0 | 0 |
| | P₂O₅ | 0 | 0 | 0 | 0 | 0 | 0 | 0 | 0 | 0 | 0 |
| | TeO₂ | 15 | 12 | 12 | 14 | 16 | 16 | 10 | 10 | 10 | 20 |
| | CeO₂ | 0.2 | 0.2 | 0.1 | 0.1 | 0.1 | 0.1 | 0 | 0 | 0 | 0 |
| | MnO₂ | 0 | 0 | 0 | 0 | 0 | 0 | 0 | 0 | 0 | 0 |
| | Bi₂O₃ + ZnO | 37 | 49 | 54 | 53 | 50 | 53 | 57 | 58 | 60 | 45 |

| | | | | | | | | | | |
|---|---|---|---|---|---|---|---|---|---|---|
| Reflectance n@ 633 nm | 1.83 | 1.89 | 1.94 | 1.93 | 1.92 | 1.94 | 1.95 | 2.11 | 2.04 | 2.03 |
| Glass transition point Tg | 434 | 428 | 414 | 421 | 420 | 418 | 420 | 379 | 381 | 404 |
| [° C.] | | | | | | | | | | |
| Liquidus temperature LT | <850 | <850 | <850 | <850 | <850 | <850 | <850 | <850 | <850 | <850 |
| [° C.] | | | | | | | | | | |
| Density d [g/cm³] | 5.00 | 5.33 | 5.57 | 5.63 | 5.53 | 5.70 | 5.73 | 6.88 | 6.50 | 6.12 |
| Wavelength λ_{T30%} [nm] | 430 | 426 | 417 | 404 | 409 | 406 | 387 | 416 | 403 | 391 |
| Haze value [%] | — | — | 2.22 | — | — | — | 0.43 | — | — | 0.19 |

TABLE 3

| | | Example | Example | Example | Example | Example | Example | Example | Example | Example | Example |
|---|---|---|---|---|---|---|---|---|---|---|---|
| | | 1-21 | 1-22 | 1-23 | 1-24 | 1-25 | 1-26 | 1-27 | 1-28 | 1-29 | 1-30 |
| Composition | Bi₂O₃ | 18 | 19 | 19 | 19 | 20 | 19 | 19 | 21 | 18 | 19 |
| (mol %) | B₂O₃ | 34 | 33 | 32 | 32 | 35 | 36 | 36 | 35 | 39.8 | 32 |
| | SiO₂ | 0 | 0 | 0 | 0 | 0 | 0 | 0 | 0 | 0 | 0 |
| | Al₂O₃ | 1 | 1 | 1 | 1 | 0 | 0 | 0 | 0 | 2 | 2 |
| | MgO | 6 | 0 | 3 | 3 | 5 | 3 | 1 | 2 | 0 | 0 |
| | SrO | 0 | 0 | 0 | 0 | 0 | 0 | 0 | 0 | 0 | 0 |
| | BaO | 0 | 5 | 3 | 3 | 1 | 0 | 0 | 0 | 10 | 6 |
| | ZnO | 36 | 35 | 34 | 34 | 33 | 37 | 36 | 37 | 30 | 36 |
| | Na₂O | 0 | 0 | 0 | 0 | 0 | 0 | 0 | 0 | 0 | 0 |
| | K₂O | 0 | 0 | 0 | 0 | 0 | 0 | 0 | 0 | 0 | 0 |
| | Nb₂O₅ | 0 | 0 | 0 | 0 | 0 | 0 | 0 | 0 | 0 | 0 |
| | TiO₂ | 0 | 2 | 0 | 3 | 0 | 0 | 1 | 1 | 0 | 0 |
| | P₂O₅ | 0 | 0 | 0 | 0 | 0 | 0 | 0 | 0 | 0 | 0 |
| | TeO₂ | 5 | 5 | 8 | 5 | 6 | 5 | 7 | 4 | 0 | 5 |
| | CeO₂ | 0 | 0 | 0 | 0 | 0 | 0 | 0 | 0 | 0.2 | 0 |
| | MnO₂ | 0 | 0 | 0 | 0 | 0 | 0 | 0 | 0 | 0 | 0 |
| | Bi₂O₃ + ZnO | 54 | 54 | 53 | 53 | 53 | 56 | 55 | 58 | 48 | 55 |

| | | | | | | | | | | |
|---|---|---|---|---|---|---|---|---|---|---|
| Reflectance n@ 633 nm | 1.94 | 1.97 | 1.96 | 1.98 | 1.97 | 1.96 | 1.97 | 1.99 | 1.89 | 1.95 |
| Glass transition point Tg | 433 | 423 | 415 | 424 | 420 | 425 | 422 | 415 | 438 | 415 |
| [° C.] | | | | | | | | | | |
| Liquidus temperature LT | 900-950 | <850 | 850-900 | 900-950 | 900-950 | 900-950 | <850 | <850 | <850 | <850 |
| [° C.] | | | | | | | | | | |
| Density d [g/cm³] | 5.69 | 5.83 | 5.82 | 5.84 | 5.88 | 5.83 | 5.82 | 6.01 | 5.48 | 5.82 |
| Wavelength λ_{T30%} [nm] | 387 | 394 | 391 | 396 | 391 | 388 | 389 | 392 | 439 | 393 |
| Haze value [%] | 1.60 | 1.19 | 1.79 | 2.05 | 0.36 | 0.30 | 0.49 | 0.60 | 23.94 | 12.36 |

TABLE 4

| | | Example | Example | Example | Example | Example | Example | Example | Example | Example | Example |
|---|---|---|---|---|---|---|---|---|---|---|---|
| | | 1-31 | 1-32 | 1-33 | 1-34 | 1-35 | 1-36 | 1-37 | 1-38 | 1-39 | 1-40 |
| Composition | Bi₂O₃ | 8.9 | 43.7 | 1 | 0 | 5 | 20 | 30 | 10 | 17 | 20 |
| (mol %) | B₂O₃ | 31 | 40.2 | 28 | 0 | 39.8 | 24.8 | 21.8 | 41.8 | 29.8 | 29.9 |
| | SiO₂ | 15.2 | 0 | 0 | 0 | 28 | 15 | 8 | 8 | 0 | 0 |
| | Al₂O₃ | 0 | 0 | 0 | 8 | 0 | 0 | 0 | 0 | 5 | 0 |
| | MgO | 0 | 0 | 0 | 0 | 0 | 0 | 0 | 0 | 0 | 0 |
| | SrO | 0 | 0 | 0 | 0 | 0 | 0 | 0 | 10 | 0 | 0 |
| | BaO | 11.2 | 0 | 0 | 13.9 | 7 | 15 | 10 | 0 | 15 | 0 |
| | ZnO | 33.5 | 1.7 | 24 | 0 | 8 | 25 | 30 | 30 | 33 | 50 |
| | Na₂O | 0 | 0 | 0 | 5.6 | 12 | 0 | 0 | 0 | 0 | 0 |
| | K₂O | 0 | 0 | 0 | 27.8 | 0 | 0 | 0 | 0 | 0 | 0 |
| | Nb₂O₅ | 0 | 0 | 0 | 3 | 0 | 0 | 0 | 0 | 0 | 0 |
| | TiO₂ | 0 | 2.6 | 0 | 0 | 0 | 0 | 0 | 0 | 0 | 0 |
| | P₂O₅ | 0 | 6 | 0 | 41.7 | 0 | 0 | 0 | 0 | 0 | 0 |
| | TeO₂ | 0 | 5.8 | 47 | 0 | 0 | 0 | 0 | 0 | 0 | 0 |
| | CeO₂ | 0.1 | 0 | 0 | 0 | 0.2 | 0.2 | 0.2 | 0.2 | 0.2 | 0.1 |
| | MnO₂ | 0.1 | 0 | 0 | 0 | 0 | 0 | 0 | 0 | 0 | 0 |
| | Bi₂O₃ + ZnO | 42.4 | 45.4 | 25 | 0 | 13 | 45 | 60 | 40 | 50 | 70 |

| | | | | | | | | | | |
|---|---|---|---|---|---|---|---|---|---|---|
| Reflectance n@ 633 nm | 1.79 | 2.11 | — | — | 1.63 | 1.92 | 2.06 | 1.78 | 1.87 | 1.98 |
| Glass transition point Tg | 502 | 422 | 390 | 414 | 489 | 436 | 388 | 500 | 424 | 412 |
| [° C.] | | | | | | | | | | |
| Liquidus temperature LT | <850 | — | — | — | <850 | <850 | <850 | <850 | >1000 | <850 |
| [° C.] | | | | | | | | | | |
| Density d [g/cm³] | 4.71 | 6.40 | 4.67 | 2.94 | 3.50 | 5.81 | 6.62 | 4.64 | 5.52 | 6.03 |
| Wavelength λ_{T30%} [nm] | 422 | 391 | 354 | — | 391 | 442 | 473 | 412 | 445 | 453 |
| Haze value [%] | — | 0.22 | — | — | 44.80 | — | — | 5.40 | — | — |

TABLE 5

| | | Example | Example | Example | Example | Example | Example |
|---|---|---|---|---|---|---|---|
| | | 1-41 | 1-42 | 1-43 | 1-44 | 1-45 | 1-46 |
| Composition | Bi₂O₃ | 35 | 10 | 10 | 30 | 30 | 29 |
| (mol %) | B₂O₃ | 26 | 37.8 | 34.8 | 32 | 24 | 25 |
| | SiO₂ | 0 | 23 | 20 | 0 | 0 | 0 |
| | Al₂O₃ | 1 | 0 | 0 | 0 | 0 | 0 |
| | MgO | 0 | 0 | 0 | 2 | 2 | 2 |
| | SrO | 0 | 0 | 5 | 0 | 0 | 0 |
| | BaO | 3 | 5 | 0 | 0 | 0 | 0 |
| | ZnO | 35 | 15 | 30 | 30 | 39 | 38 |
| | Na₂O | 0 | 9 | 0 | 0 | 0 | 0 |
| | K₂O | 0 | 0 | 0 | 0 | 0 | 0 |
| | Nb₂O₅ | 0 | 0 | 0 | 0 | 0 | 0 |
| | TiO₂ | 0 | 0 | 0 | 1 | 0 | 0 |
| | P₂O₅ | 0 | 0 | 0 | 0 | 0 | 0 |
| | TeO₂ | 0 | 0 | 0 | 5 | 5 | 6 |
| | CeO₂ | 0 | 0.2 | 0.2 | 0 | 0 | 0 |
| | MnO₂ | 0 | 0 | 0 | 0 | 0 | 0 |
| | Bi₂O₃ + ZnO | 70 | 25 | 40 | 60 | 69 | 67 |

| | | | | | | |
|---|---|---|---|---|---|---|
| Reflectance n@ 633 nm | 2.04 | 1.72 | 1.77 | 2.06 | 2.09 | 2.07 |
| Glass transition point Tg | 389 | 466 | 505 | 401 | 372 | 375 |
| [° C.] | | | | | | |
| Liquidus temperature LT | <850 | <850 | <850 | <850 | <850 | <850 |
| [° C.] | | | | | | |
| Density d [g/cm³] | 6.36 | 4.19 | 4.54 | 6.47 | 6.72 | 6.64 |
| Wavelength λ_{T30%} [nm] | 402 | 415 | 387 | 402 | 407 | 404 |
| Haze value [%] | — | 12.59 | 0.39 | 0.47 | 0.54 | 0.24 |

### Example 2

### Manufacture of the Optical Conversion Member

Next, the optical conversion members were manufactured as follows using the glass powders obtained in Example 1. Note that as the phosphor particles to be dispersed in the glasses, a Ce-activated YAG phosphor having a 50% particle diameter D₅₀ of 10 μm and a phosphor peak wavelength of about 555 nm excited at 460 nm, an Eu-activated CASN phosphor having a 50% particle diameter D₅₀ of 11 μm and a phosphor peak wavelength of about 628 nm excited at 460 nm, an Eu-activated SrGa₂S₄ phosphor having a 50% particle diameter D₅₀ of 10 μm and a phosphor peak wavelength of about 536 nm excited at 460 nm, and an Eu-activated Sr₂Si₅N₈ phosphor having a phosphor peak wavelength of about 627 nm excited at 460 nm were used. Besides, the frits (glass powders) used here were described with glass numbers given to them to correspond to numbers of Example 1 such that the glass obtained in Example 1-1 was Glass 1, the glass obtained in Example 1-2 was Glass 2 and so on.

The glass powder, the phosphor particles, and the heat-resistant filler were mixed together so that the total amount was 100% in volume fraction in each of combinations of the glass and the phosphor as listed in Tables 6 to 11. Note that as the heat-resistant filler, single crystal alumina having a 50% particle diameter D₅₀ of 18 μm and a refractive index at a wavelength of 633 nm of 1.76 was used. Besides, “CASN+YAG” and “2+18” of Example 2-19 indicate that a CASN phosphor and a YAG phosphor are mixed at fractions of 2 vol % and 18 vol % respectively. Further, the mixture was kneaded with the vehicle and defoamed, whereby slurry was obtained. As the vehicle, the one made by dissolving 25 parts by mass of an acrylic resin in 75 parts by mass of a mixed solvent of toluen, xylene, isopropanol, and 2-butanol was used. Further, as the diluent solvent, a mixed solvent of toluen, xylene, isopropanol, and 2-butanol was used to adjust a slurry viscosity of about 5000 cP. This slurry was applied to a PET film (manufactured by Teijin Limited) by the doctor blade method. This was dried for about 30 minutes in the drying furnace and cut out into a size of about 7 cm square, and the PET film was peeled, whereby a green sheet with a thickness of 0.5 to 0.7 mm was obtained.

This was put on a mullite substrate coated with a release agent, and the optical conversion member was manufactured under each of the firing conditions listed in Tables 6 to 11. The thicknesses of the obtained optical conversion members were 0.14 to 0.16 mm. Note that “Air” of the firing atmosphere indicates atmosphere firing, “N2” indicates nitrogen firing with flow of N₂ at 0.3 L/min, and “LP” indicates reduced-pressure firing of an ultimate vacuum of about 60 Pa.

For the obtained optical conversion members in Examples 2-1 to 2-45, the quantum conversion yield and chromaticity coordinates x, y were measured.

The quantum conversion yield of the optical conversion member was measured by cutting out a central portion of the obtained optical conversion member into a size of 1 cm square and using an absolute PL quantum yield measuring system (manufactured by Hamamatsu Photonics K.K., trade name: Quantauru-QY), at an excitation light wavelength of 460 nm. Further, in this event, the chromaticity coordinates x, y can also be obtained at the same time.

TABLE 6

| | Example | Example | Example | Example | Example | Example | Example | Example |
|---|---|---|---|---|---|---|---|---|
| | 2-1 | 2-2 | 2-3 | 2-4 | 2-5 | 2-6 | 2-7 | 2-8 |
| Frit | Glass 4 | Glass 4 | Glass 4 | Glass 4 | Glass 4 | Glass 4 | Glass 4 | Glass 4 |
| Phosphor | CASN | CASN | CASN | CASN | CASN | CASN | YAG | YAG |
| Frit amount | 80 | 80 | 80 | 80 | 80 | 80 | 80 | 80 |
| [vol %] | | | | | | | | |
| Phosphor | 20 | 20 | 20 | 20 | 20 | 20 | 20 | 20 |
| amount | | | | | | | | |
| [vol %] | | | | | | | | |
| Filler amount | 0 | 0 | 0 | 0 | 0 | 0 | 0 | 0 |
| [vol %] | | | | | | | | |
| Decalcification | 360 | 360 | 360 | 320 | 320 | 360 | 380 | 360 |
| temperature | | | | | | | | |
| [° C.] | | | | | | | | |
| Decalcification | 8 | 8 | 8 | 8 | 8 | 8 | 8 | 8 |
| time [h] | | | | | | | | |
| Firing | N2 | LP | Air | N2 | LP | Air | N2 | N2 |
| atmosphere | | | | | | | | |
| Firing | 460 | 480 | 480 | 460 | 480 | 460 | 460 | 460 |
| temperature | | | | | | | | |
| [° C.] | | | | | | | | |
| Firing time [h] | 1 | 1 | 1 | 1 | 1 | 1 | 1 | 1 |
| Quantum yield | 80 | 86 | 85 | 83 | 81 | 87 | 92 | 93 |
| [%] | | | | | | | | |
| Chromaticity | 0.232 | 0.227 | 0.25 | 0.214 | 0.238 | 0.223 | 0.215 | 0.211 |
| coordinate x | | | | | | | | |
| Chromaticity | 0.066 | 0.061 | 0.078 | 0.052 | 0.07 | 0.058 | 0.115 | 0.117 |
| coordinate y | | | | | | | | |

TABLE 7

| | Example | Example | Example | Example | Example | Example | Example | Example |
|---|---|---|---|---|---|---|---|---|
| | 2-9 | 2-10 | 2-11 | 2-12 | 2-13 | 2-14 | 2-15 | 2-16 |
| Frit | Glass 5 | Glass 5 | Glass 7 | Glass 8 | Glass 13 | Glass 17 | Glass 17 | Glass 17 |
| Phosphor | CASN | CASN | CASN | CASN | CASN | CASN | YAG | YAG |
| Frit amount | 80 | 71 | 80 | 80 | 80 | 80 | 80 | 80 |
| [vol %] | | | | | | | | |
| Phosphor | 20 | 20 | 20 | 20 | 20 | 20 | 20 | 20 |
| amount | | | | | | | | |
| [vol %] | | | | | | | | |
| Filler amount | 0 | 9 | 0 | 0 | 0 | 0 | 0 | 0 |
| [vol %] | | | | | | | | |
| Decalcification | 380 | 380 | 360 | 360 | 380 | 360 | 380 | 360 |
| temperature | | | | | | | | |
| [° C.] | | | | | | | | |
| Decalcification | 8 | 8 | 8 | 8 | 8 | 8 | 8 | 8 |
| time [h] | | | | | | | | |
| Firing | Air | Air | Air | Air | Air | Air | N2 | N2 |
| atmosphere | | | | | | | | |
| Firing | 480 | 480 | 490 | 490 | 480 | 460 | 460 | 460 |
| temperature | | | | | | | | |
| [° C.] | | | | | | | | |
| Firing time [h] | 1 | 1 | 1 | 1 | 1 | 1 | 1 | 1 |
| Quantum yield | 92 | 89 | 80 | 84 | 86 | 87 | 87 | 90 |
| [%] | | | | | | | | |
| Chromaticity | 0.246 | 0.233 | 0.212 | 0.221 | 0.232 | 0.236 | 0.218 | 0.206 |
| coordinate x | | | | | | | | |
| Chromaticity | 0.074 | 0.066 | 0.051 | 0.058 | 0.067 | 0.068 | 0.121 | 0.099 |
| coordinate y | | | | | | | | |

TABLE 8

| | Example | Example | Example | Example | Example | Example | Example | Example |
|---|---|---|---|---|---|---|---|---|
| | 2-17 | 2-18 | 2-19 | 2-20 | 2-21 | 2-22 | 2-23 | 2-24 |
| Frit | Glass 24 | Glass 25 | Glass 25 | Glass 25 | Glass 25 | Glass 28 | Glass 28 | Glass 28 |
| Phosphor | CASN | CASN | CASN + | YAG | SrGa₂S₄ | CASN | YAG | SrGa₂S₄ |
| | | | YAG | | | | | |
| Frit amount | 80 | 80 | 80 | 80 | 86 | 80 | 80 | 86 |
| [vol %] | | | | | | | | |
| Phosphor | 20 | 20 | 2 + 18 | 20 | 5 | 20 | 20 | 5 |
| amount | | | | | | | | |
| [vol %] | | | | | | | | |
| Filler amount | 0 | 0 | 0 | 0 | 9 | 0 | 0 | 9 |
| [vol %] | | | | | | | | |
| Decalcification | 320 | 320 | 320 | 320 | 320 | 320 | 320 | 320 |
| temperature | | | | | | | | |
| [° C.] | | | | | | | | |
| Decalcification | 8 | 8 | 8 | 8 | 8 | 8 | 8 | 8 |
| time [h] | | | | | | | | |
| Firing | Air | Air | Air | Air | LP | Air | Air | LP |
| atmosphere | | | | | | | | |
| Firing | 480 | 480 | 480 | 480 | 480 | 460 | 460 | 470 |
| temperature | | | | | | | | |
| [° C.] | | | | | | | | |
| Firing time [h] | 1 | 1 | 1 | 1 | 1 | 1 | 1 | 1 |
| Quantum yield | 88 | 86 | 90 | 95 | 80 | 92 | 95 | 84 |
| [%] | | | | | | | | |
| Chromaticity | 0.236 | 0.232 | 0.238 | 0.218 | 0.18 | 0.241 | 0.226 | 0.182 |
| coordinate x | | | | | | | | |
| Chromaticity | 0.077 | 0.074 | 0.117 | 0.123 | 0.137 | 0.071 | 0.136 | 0.151 |
| coordinate y | | | | | | | | |

TABLE 9

| | Example | Example | Example | Example | Example | Example | Example | Example |
|---|---|---|---|---|---|---|---|---|
| | 2-25 | 2-26 | 2-27 | 2-28 | 2-29 | 2-30 | 2-31 | 2-32 |
| Frit | Glass 31 | Glass 31 | Glass 31 | Glass 32 | Glass 33 | Glass 34 | Glass 34 | Glass 35 |
| Phosphor | CASN | YAG | YAG | CASN | CASN | CASN | CASN | YAG |
| Frit amount | 80 | 80 | 80 | 80 | 80 | 80 | 80 | 80 |
| [vol %] | | | | | | | | |
| Phosphor | 20 | 20 | 20 | 20 | 20 | 20 | 20 | 20 |
| amount | | | | | | | | |
| [vol %] | | | | | | | | |
| Filler amount | 0 | 0 | 0 | 0 | 0 | 0 | 0 | 0 |
| [vol %] | | | | | | | | |
| Decalcification | 380 | 380 | 380 | 360 | 360 | 360 | 360 | 380 |
| temperature | | | | | | | | |
| [° C.] | | | | | | | | |
| Decalcification | 4 | 4 | 4 | 8 | 8 | 8 | 8 | 4 |
| time [h] | | | | | | | | |
| Firing | LP | LP | N2 | LP | LP | LP | Air | LP |
| atmosphere | | | | | | | | |
| Firing | 570 | 575 | 590 | 460 | 460 | 460 | 460 | 570 |
| temperature | | | | | | | | |
| [° C.] | | | | | | | | |
| Firing time [h] | 1 | 1 | 1 | 1 | 1 | 1 | 1 | 1 |
| Quantum yield | 42 | 90 | 92 | 62 | 16 | 67 | 65 | 69 |
| [%] | | | | | | | | |
| Chromaticity | 0.213 | 0.236 | 0.251 | 0.19 | 0.177 | 0.202 | 0.231 | 0.215 |
| coordinate x | | | | | | | | |
| Chromaticity | 0.052 | 0.152 | 0.18 | 0.036 | 0.025 | 0.044 | 0.065 | 0.114 |
| coordinate y | | | | | | | | |

TABLE 10

| | Example | Example | Example | Example | Example | Example | Example | Example |
|---|---|---|---|---|---|---|---|---|
| | 2-33 | 2-34 | 2-35 | 2-36 | 2-37 | 2-38 | 2-39 | 2-40 |
| Frit | Glass 36 | Glass 36 | Glass 36 | Glass 39 | Glass 40 | Glass 40 | Glass 41 | Glass 41 |
| Phosphor | CASN | CASN | YAG | CASN | CASN | CASN | CASN | CASN |
| Frit amount | 80 | 80 | 80 | 80 | 80 | 80 | 80 | 80 |
| [vol %] | | | | | | | | |
| Phosphor | 20 | 20 | 20 | 20 | 20 | 20 | 20 | 20 |
| amount | | | | | | | | |
| [vol %] | | | | | | | | |
| Filler amount | 0 | 0 | 0 | 0 | 0 | 0 | 0 | 0 |
| [vol %] | | | | | | | | |
| Decalcification | 380 | 380 | 380 | 360 | 360 | 360 | 360 | 360 |
| temperature | | | | | | | | |
| [° C.] | | | | | | | | |
| Decalcification | 4 | 4 | 4 | 8 | 8 | 8 | 8 | 8 |
| time [h] | | | | | | | | |
| Firing | N2 | N2 | N2 | LP | LP | Air | LP | Air |
| atmosphere | | | | | | | | |
| Firing | 490 | 510 | 490 | 480 | 460 | 460 | 440 | 440 |
| temperature | | | | | | | | |
| [° C.] | | | | | | | | |
| Firing time [h] | 1 | 1 | 1 | 1 | 1 | 1 | 1 | 1 |
| Quantum yield | 70 | 50 | 87 | 68 | 62 | 36 | 47 | 45 |
| [%] | | | | | | | | |
| Chromaticity | 0.255 | 0.222 | 0.211 | 0.196 | 0.196 | 0.197 | 0.162 | 0.192 |
| coordinate x | | | | | | | | |
| Chromaticity | 0.082 | 0.059 | 0.145 | 0.038 | 0.04 | 0.041 | 0.014 | 0.037 |
| coordinate y | | | | | | | | |

TABLE 11

| | Example | Example | Example | Example | Example |
|---|---|---|---|---|---|
| | 2-41 | 2-42 | 2-43 | 2-44 | 2-45 |
| Frit | Glass 44 | Glass 45 | Glass 45 | Glass 46 | Glass 46 |
| Phosphor | CASN | CASN | Ca₂Si₅N₈ | CASN | Ca₂Si₅N₈ |
| Frit amount | 80 | 80 | 85 | 80 | 85 |
| [vol %] | | | | | |
| Phosphor | 5 | 5 | 10.8 | 5 | 10.8 |
| amount | | | | | |
| [vol %] | | | | | |
| Filler | 15 | 15 | 4.2 | 15 | 4.2 |
| amount | | | | | |
| [vol %] | | | | | |
| Decalcifi- | 360 | 320 | 320 | 320 | 320 |
| cation | | | | | |
| temperature | | | | | |
| [° C.] | | | | | |
| Decalcifi- | 4 | 4 | 4 | 4 | 4 |
| cation | | | | | |
| time [h] | | | | | |
| Firing | Air | Air | Air | Air | Air |
| atmosphere | | | | | |
| Firing | 440 | 420 | 420 | 420 | 420 |
| temperature | | | | | |
| [° C.] | | | | | |
| Firing time | 1 | 0.5 | 0.5 | 0.5 | 0.5 |
| [h] | | | | | |
| Quantum | 90 | 92 | 89 | 87 | 95 |
| yield [%] | | | | | |
| Chromaticity | 0.242 | 0.233 | 0.217 | 0.231 | 0.215 |
| coordinate x | | | | | |
| Chromaticity | 0.086 | 0.075 | 0.063 | 0.074 | 0.062 |
| coordinate y | | | | | |

As is clear from Tables 6 to 11, Examples 2-1 to 2-24 and 2-41 to 45 use the glasses of the present invention in which the glass sufficiently flows at a firing temperature of 500° C. or lower, excitation light can be sufficiently applied to the phosphor because λ_{T30%} is a wavelength shorter than 460 nm, and a high quantum conversion yield of 80% or more can be obtained even if the phosphor is YAG, CASN, SrGa₂S₄, or Ca₂Si₅N₈ phosphor because the reaction between the phosphor and the glass can be suppressed.

On the other hand, in Glass 31 of Example 1-31 being a comparative example, in which the content of SiO₂ is high and Tg is higher than 500° C., the firing temperature therefore needs to be made higher in order to cause sufficient flow of the glass. Therefore, high quantum conversion yields can be obtained in Examples 2-26, 2-27 using YAG for the phosphor, whereas an obvious decrease in quantum conversion yield is seen in Example 2-25 using CASN for the phosphor. Also in Glass 36 of Example 1-36 in which the content of SiO₂ is almost the same as that of Glass 31 and Tg is lower than 450° C., the firing temperature can be made to 500° C. or lower. A high quantum conversion yield can be obtained in Example 2-35 using YAG for the phosphor, whereas a decrease in quantum conversion yield is seen in Examples 2-33, 2-34 using CASN for the phosphor. In particular, in Example 2-34 produced at a firing temperature of 510° C., a large decrease in quantum conversion yield is seen as compared to Example 2-33 in which the firing temperature is made to 500° C. or lower. This shows that the firing temperature needs to be made to lower than 500° C.

Glass 32 of Example 1-32, in which Bi₂O₃ is more than 35%, is crystalized during firing even though Tg is lower than 450° C., and is low in quantum conversion yield as indicated in Example 2-28. Besides, Example 2-29 using Glass 33 of Example 1-33, in which TeO₂ is more than 20%, causes a significant decrease in quantum conversion yield due to reaction between the phosphor and the glass. In Examples 2-30 to 2-32 using Glass 34 of Example 1-34 and Glass 35 of Example 1-35, in which the content of alkali is more than 10%, the quantum conversion yield is low due to reaction between the phosphor and the glass.

Glass 37 of Example 1-37, in which B₂O₃ is less than 22% and λ_{T30%} is more than 460 nm, is predicted that excitation light is not sufficiently applied to the phosphor because the glass absorbs the excitation light. Examples 1-38, 1-42, 1-43, in which Tg is higher than 450° C. and the firing temperature is higher than 500° C., are predicted that the quantum conversion yield decreases when the CASN phosphor is used. Glass 39 of Example 1-39, in which Al₂O₃ is more than 4% and LT of 1000° C. is higher, may be difficult to melt in a gold crucible. Further, though Tg is lower than 450° C., sufficient flow is not generated during firing and the quantum conversion yield is low as indicated in Example 2-36.

Glass 40 of Example 1-40 and Glass 41 of Example 1-41, in which Bi₂O₃+ZnO is 70%, are crystalized during firing even though Tg is lower than 450° C., and sufficient flow is not generated and the quantum conversion yields are low as indicated in Examples 2-37 to 2-40.

As described above, the glass composition of the present invention is low in Tg and therefore can be sintered at low temperature and can manufacture the optical conversion member without impairing the activity of the phosphor. Thus obtained optical conversion member is preferable because it is high in light conversion efficiency and high in use efficiency of light.

Besides, as listed in Tables 2 to 3, Examples 1-13 to 1-28 in a range of the glass composition in the second embodiment, in which the haze value is 10% or less, are excellent in weather resistance. Therefore, the optical conversion members using the glasses can be made to also have sufficient weather resistance in practical use.

A glass composition of the present invention can manufacture an optical conversion member without impairing the activity of phosphor particles, the optical conversion member of the present invention can be easily manufactured while keeping the activity of phosphor particles and has an excellent light conversion efficiency with excellent transmitting property for light from a light source, and a light emitting device of the present invention uses the above-described optical conversion member and is therefore suitable for illumination use.

What is claimed is:

1. A glass composition comprising, in mol % based on oxides, 5 to 35% of Bi₂O₃, 22 to 80% of B₂O₃, 10 to 48% of ZnO, and 0 to 4% of Al₂O₃, and not substantially containing SiO₂, wherein a total amount of the Bi₂O₃ and the ZnO being 15% or more and less than 70%.

2. A glass composition comprising, in mol % based on oxides, 5 to 35% of Bi₂O₃, 22 to 80% of B₂O₃, 10 to 48% of ZnO, 0 to 20% of TeO₂, 0 to 4% of Al₂O₃, 0 to 20% of MgO, 0 to 20% of CaO, 0 to 20% of SrO, 0 to 20% of BaO, 0 to 10% of Li₂O, 0 to 10% of Na₂O, 0 to 10% of K₂O, and 0 to 0.5% of CeO₂, and not substantially containing SiO₂, wherein a total amount of the Bi₂O₃ and the ZnO being 15% or more and less than 70%.

3. The glass composition according to claim 2,
wherein the Bi₂O₃ is 8 to 32%, the B₂O₃ is 25 to 60%, the ZnO is 15 to 45%, the TeO₂ is 0 to 16%, the Al₂O₃ is 0 to 3%, the MgO is 0 to 16%, the CaO is 0 to 16%, the SrO is 0 to 16%, the BaO is 0 to 20%, the Li₂O is 0 to 5%, the Na₂O is 0 to 5%, the K₂O is 0 to 5%, and the CeO₂ is 0 to 0.2%.

4. The glass composition according to claim 3,
wherein the Bi₂O₃ is 10 to 30%, the B₂O₃ is 25 to 55%, the ZnO is 20 to 43%, the TeO₂ is 0 to 14%, the Al₂O₃ is 0 to 3%, the BaO is 1 to 15%, the CeO₂ is 0 to 0.1%, and the total amount of the Bi₂O₃ and the ZnO is 20% or more and 65% or less.

5. The glass composition according to claim 4,
wherein the Bi₂O₃ is 15 to 27%, the B₂O₃ is 25 to 45%, the ZnO is 25 to 40%, the TeO₂ is 0 to 12%, the Al₂O₃ is 0 to 2%, the BaO is 1 to 10%, the CeO₂ is 0 to 0.1%, and the total amount of the Bi₂O₃ and the ZnO is 40% or more and 55% or less.

6. The glass composition according to claim 2,
wherein a total amount of the MgO, the CaO, the SrO and the BaO is 0 to 20%.

7. The glass composition according to claim 2,
wherein a total amount of the Li₂O, the Na₂O and the K₂O is 0 to 10%.

8. A glass composition comprising, in mol % based on oxides, 5 to 35% of Bi₂O₃, 22 to 43% of B₂O₃, 10 to 48% of ZnO, 1 to 20% of TeO₂, 0 to 4% of Al₂O₃, 0 to 10% of MgO, 0 to 10% of CaO, 0 to 10% of SrO, 0 to 5% of BaO, 0 to 5% of Li₂O, 0 to 5% of Na₂O, 0 to 5% of K₂O, 0 to 5% of TiO₂, 0 to 5% of ZrO₂, and 0 to 5% of Nb₂O₅, and not substantially containing SiO₂, wherein a total amount of the Bi₂O₃ and the ZnO being 15% or more and less than 70%.

9. The glass composition according to claim 8,
wherein a total amount of the MgO, the CaO, the SrO and the BaO is 0 to 10%.

10. The glass composition according to claim 8,
wherein a total amount of the Li₂O, the Na₂O and the K₂O is 0 to 5%.

11. The glass composition according to claim 8,
wherein a total amount of the TiO₂, the ZrO₂ and the Nb₂O₅ is 0 to 5%.

12. A method for manufacturing glass, comprising:
melting the glass composition according to claim 1 at a melting temperature of 1000° C. or lower with a gold crucible, and then cooling and solidifying the melted glass composition.

13. An optical conversion member composed of glass containing dispersed phosphor particles,
wherein the glass is formed of the glass composition according to claim 1.

14. The optical conversion member according to claim 13,
wherein the phosphor particle has an excitation band at a wavelength of 400 to 500 nm and an emission peak at a wavelength of 500 to 700 nm, and is one or more compounds selected from a group consisting of oxide, nitride, and oxynitride.

15. The optical conversion member according to claim 14,
wherein the phosphor particle contains one or more compounds selected from a group consisting of a garnet-based crystal, a CASN-based crystal (Ca(Sr)AlSiN₃), and a SiAlON-based crystal.

16. The optical conversion member according to claim 13,
wherein the glass has a glass transition point Tg calculated from a DTA curve of 300 to 450° C.

17. The optical conversion member according to claim 13,
wherein the glass has a wavelength of a transmittance 30% at a glass thickness of 1 mm being shorter than 460 nm.

18. The optical conversion member according to claim 13,
wherein a quantum conversion yield of the optical conversion member is 80% or more.

19. An illumination light source comprising the optical conversion member according to claim 13, and a light source capable of radiating light to an outside through the optical conversion member.

20. The illumination light source according to claim 19,
wherein the light source is an LED element.

21. A liquid crystal display device comprising a liquid crystal display panel and a backlight illuminating the liquid crystal display panel,
wherein the backlight is an illumination light source composed of the optical conversion member according to claim 13 and a light source capable of radiating light to an outside through the optical conversion member.

22. A method for manufacturing an optical conversion member comprising:
kneading a glass powder formed of the glass composition according to claim 1, phosphor particles, a resin, and an organic solvent to form slurry,
forming the obtained slurry into a desired shape, and
firing the slurry of the desired shape into an optical conversion member at 500° C. or lower.

23. The method for manufacturing an optical conversion member according to claim 22,
wherein in the kneading, a heat-resistant filler is also added and kneaded into slurry.

24. The method for manufacturing an optical conversion member according to claim 22,
wherein the glass powder is obtained by melting the glass composition at a melting temperature of 1000° C. or lower with a gold crucible, then cooling and solidifying the melted glass composition, and thereafter grinding the solidified glass composition.
